(19) United States
(12) Patent Application Publication
(10) Pub. No.: US 2011/0199758 A1
(43) Pub. Date: Aug. 18, 2011

(54) Stretch-resistant light-emitting or heat-emitting structure combined with battery

(76) Inventor: Ming-Hsiang Yeh, Taipei City (TW)

(21) Appl. No.: 12/929,599

(22) Filed: Feb. 3, 2011

(30) Foreign Application Priority Data
Feb. 12, 2010 (TW) 099203157

(51) Int. Cl. F21L 4/02

(52) U.S. Cl. 362/184

(57) ABSTRACT

The present invention provides a stretch-resistant light-emitting or heat-emitting structure, which is applicable to an article. The stretch-resistant light-emitting structure includes a woven member, conductive twisted cables, a light-emitting element, and a battery. The woven member is mounted to the article. Each conductive twisted cable includes a stretch-resistant wire and a conductive wire twisted together. The conductive twisted cables are woven in the woven member. The light-emitting element, which is arranged inside the woven member, includes a light emission section and two conductive pins. The light emission section emits light projecting out of the woven member. The conductive pins and the battery are respectively and electrically connected to the conductive wires of the conductive twisted cables. The stretch-resistant heat-emitting structure includes a carrying member, an electrical heating element mounted to the carrying member, the conductive twisted cables that are in electrical connection with the electrical heating element, and the battery that is in electrical connection with the conductive twisted cables. The carrying member is woven in the article. As such, besides being capable of emission of light or heat, the article features stretch resistance, pull resistance, water washability, and deflectability.

### FIELD OF THE INVENTION

The present invention relates to a stretch-resistant light-emitting or heat-emitting structure, and in particular to a stretch-resistant light-emitting or heat-emitting structure that is combined with a battery, is applicable to an article to be worn on a human body, and shows the properties of stretch resistance, pull resistance, water washability, and deflectability, and also features light emission and/or heat emission.

### BACKGROUND OF THE INVENTION

Conventionally, to additionally mount a light-emitting structure or a heat-emitting structure to an article to be worn on a human body (such as garment, jacket, shirt, vest, underwear, pants, skirt, hat, glove, swimming suit, swimming cap, wet suit, sock, earmuffs, and bag and backpack) for emission of light or for heating purposes, the only practice that was known is to mount light-emitting elements to a jacket or a hat to improve nighttime atmosphere, amusing, or aesthetics effect.

However, the article to be worn on a human body must be subjected to cleaning, which is often done with water. During water washing, the article is stretched, twisted, and deflected and this makes the conventional way of simply attaching light-emitting structure to the article not fit, for water washing operation or otherwise stretching and deflecting the article may lead to breaking of power supply wires.

Thus, it is desired to provide a stretch-resistant light-emitting or heat-emitting structure that shows the properties of stretch resistance, pull resistance, water washability, and deflectability and is also capable of emitting light and/or heat. This is the primary objective of the present invention.

### SUMMARY OF THE INVENTION

An objective of the present invention is to provide a stretch-resistant light-emitting structure, which comprises a unique arrangement of conductive twisted cables to ensure stretch resistance, pull resistance, water washability, and deflectability, and realizes electrical conduction to transmit electrical power from a battery for energizing and lighting a light-emitting element.

To achieve the above objective, the present invention provides a stretch-resistant light-emitting structure, which is applicable to an article. The stretch-resistant light-emitting structure comprises a woven member, at least two conductive twisted cables, at least one light-emitting element, and a battery. The woven member is mounted to the article. Each of the conductive twisted cables comprises at least one stretch-resistant wire and at least one conductive wire twisted together, and the two conductive twisted cables are woven in the woven member. The light-emitting element is arranged inside the woven member, and the light-emitting element comprises a light emission section and at least two conductive pins. The light emission section emits light projecting out of the woven member. The two conductive pins are respectively and securely in electrical engagement with the conductive wires of the two conductive twisted cables. The battery is electrically connected to the conductive wires of the two conductive twisted cables to supply electrical power to the light-emitting element.

As such, besides being powered by the battery for emission of light, the article also features stretch resistance, pull resistance, water washability, and deflectability.

A secondary objective of the present invention is to provide a stretch-resistant heat-emitting structure, which comprises a unique arrangement of conductive twisted cables to ensure stretch resistance, pull resistance, water washability, and deflectability, and realizes electrical conduction to transmit electrical power from a battery for powering a heat-emitting element to give off heat.

To achieve the above objective, the present invention provides a stretch-resistant heat-emitting structure, which is applicable to an article. The stretch-resistant heat-emitting structure comprises at least one carrying member, at least one electrical heating element, at least two conductive twisted cables, and a battery. The carrying member is woven in the article. The electrical heating element is mounted to the carrying member. Each of the conductive twisted cables comprises at least one stretch-resistant wire and at least one conductive wire twisted together. The conductive wires of the two conductive twisted cables each have an end electrically connected to the electrical heating element. The battery is electrically connected to an opposite end of each of the conductive wires of the conductive twisted cables for supply of electrical power thereto.

As such, besides being powered by the battery for emission of heat for warm keeping purposes, the article also features stretch resistance, pull resistance, water washability, and deflectability.

### BRIEF DESCRIPTION OF THE DRAWINGS

The present invention will be apparent to those skilled in the art by reading the following description of preferred embodiments thereof with reference to the drawings, in which:

FIG. 1 is a schematic view showing the present invention applied to a front of an article;

FIG. 2 is a schematic view showing the present invention applied to a back of an article;

FIG. 3 is a perspective view of a conductive twisted cable according to the present invention;

FIG. 3A is a cross-sectional view taken along line A-A of FIG. 3;

FIG. 4 is a perspective view showing a stretch-resistant light-emitting structure according to the present invention;

FIG. 4A is a cross-sectional view taken along line B-B of FIG. 4, also showing a control circuit, a battery, and a switch electrically connected to the conductive twisted cable;

FIG. 4B shows an embodiment formed by modifying the embodiment of FIG. 4A by adding positioning troughs;

FIG. 5 shows an embodiment of the stretch-resistant light-emitting structure according to the present invention wherein light-emitting elements are arranged between two conductive twisted cables;

FIG. 5A shows an embodiment formed by modifying the embodiment of FIG. 5 by adding positioning trough;

FIG. 6 shows an embodiment of the stretch-resistant light-emitting structure according to the present invention, wherein another light-emitting element is used;

FIG. 7 shows an embodiment of the stretch-resistant light-emitting structure according to the present invention, wherein another the light-emitting element having piercing tips is used;

FIG. 8 is a schematic view showing a stretch-resistant light-emitting structure according to the present invention, wherein connectors are used to connect a battery and a control circuit that are provided externally;

FIG. 9 is a schematic view showing a stretch-resistant heat-emitting structure according to the present invention, wherein connectors are used to connect a battery and a control circuit that are provided externally (being already mounted to an article); and

FIG. 10 is a circuit diagram according to the present invention.

### DETAILED DESCRIPTION OF THE PREFERRED EMBODIMENTS

The present invention provides a stretch-resistant light-emitting or heat-emitting structure, which is applied to an article to be put on the body of a user (such as garment, jacket, shirt, vest, underwear, pants, skirt, hat, glove, swimming suit, swimming cap, wet suit, sock, earmuffs, and bag and backpack).

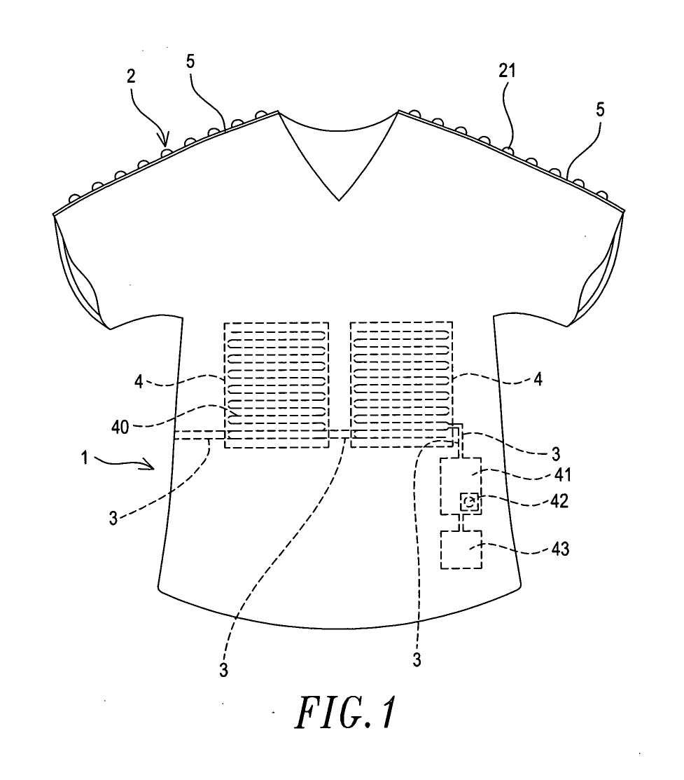

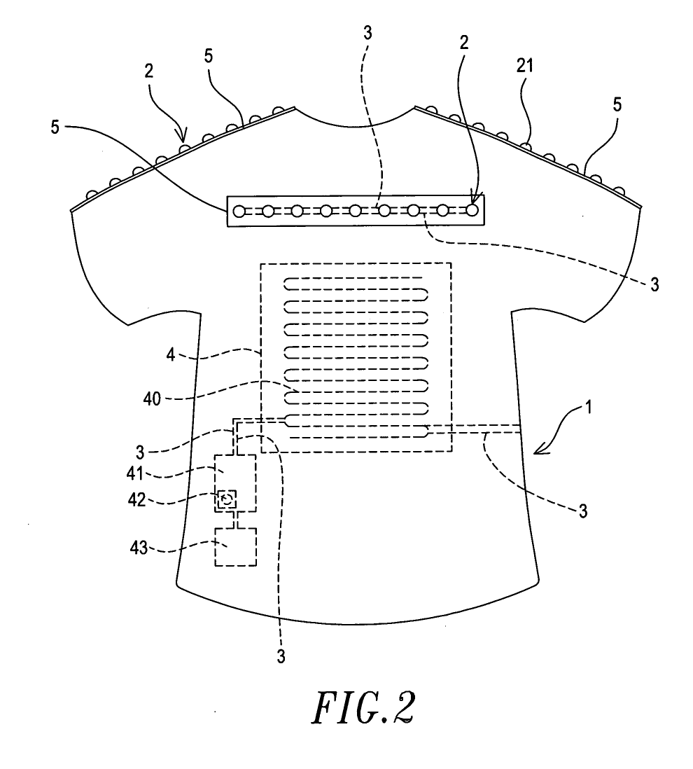

With reference to the drawings and in particular to FIGS. 1 and 2, an article 1 (which in the embodiment illustrated in the drawings is a garment) is provided with a plurality of stretch-resistant light-emitting structures and a plurality of stretch-resistant heat-emitting structure. Referring to FIGS. 1-4, the stretch-resistant light-emitting structures are respectively mounted to shoulders and back of the article 1. Each stretch-resistant light-emitting structure comprises a woven member 5, at least two conductive twisted cables 3, and at least one light-emitting element 2. In the embodiment shown in the drawings, the stretch-resistant light-emitting structure comprises two conductive twisted cables 3 and a plurality of the light-emitting elements 2. The light-emitting element 2 can be a light-emitting diode (LED) or an organic light-emitting diode (OLED).

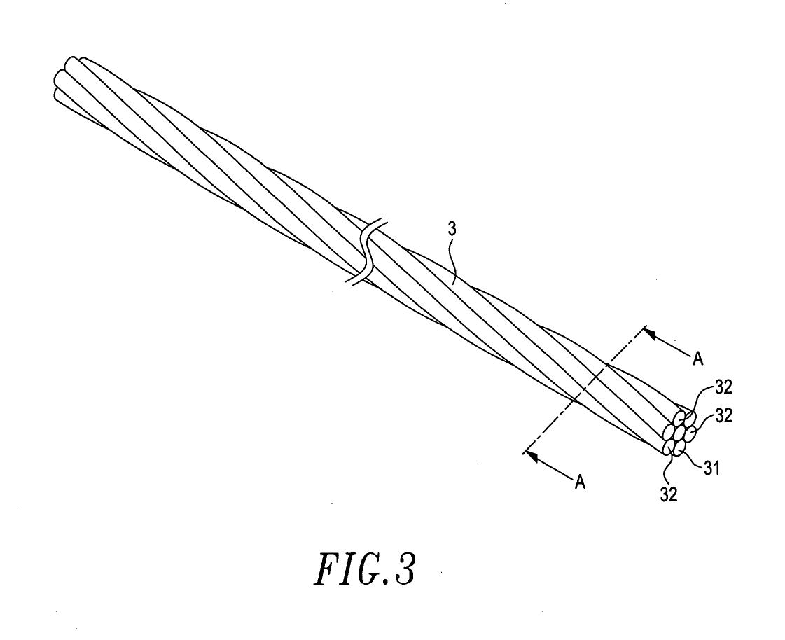

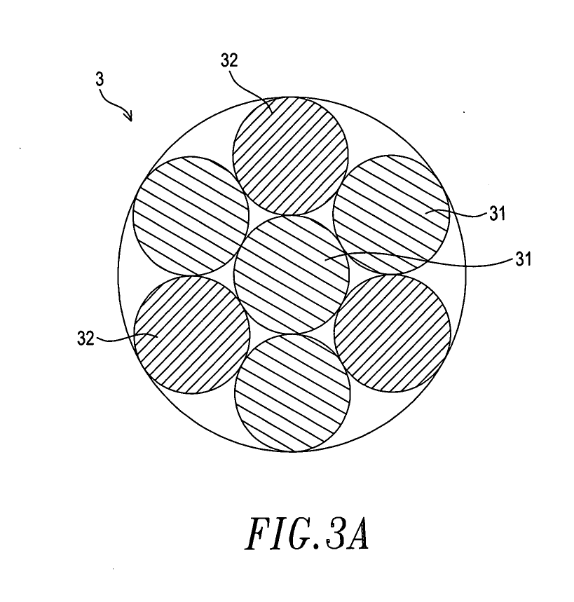

As to the conductive twisted cables 3, as shown in FIGS. 3 and 3A, each conductive twisted cable 3 comprises at least one stretch-resistant wire 31 and at least one conductive wire 32 twisted together. In the embodiment illustrated, the conductive twisted cable 3 comprises a plurality of stretch-resistant wires 31 and a plurality of conductive wires 32. Preferably, each conductive wire 32 is a conductive wire made of a stretch-resistant material to provide the conductive wire 32 with the properties of stretch resistance, pull resistance, and deflectability.

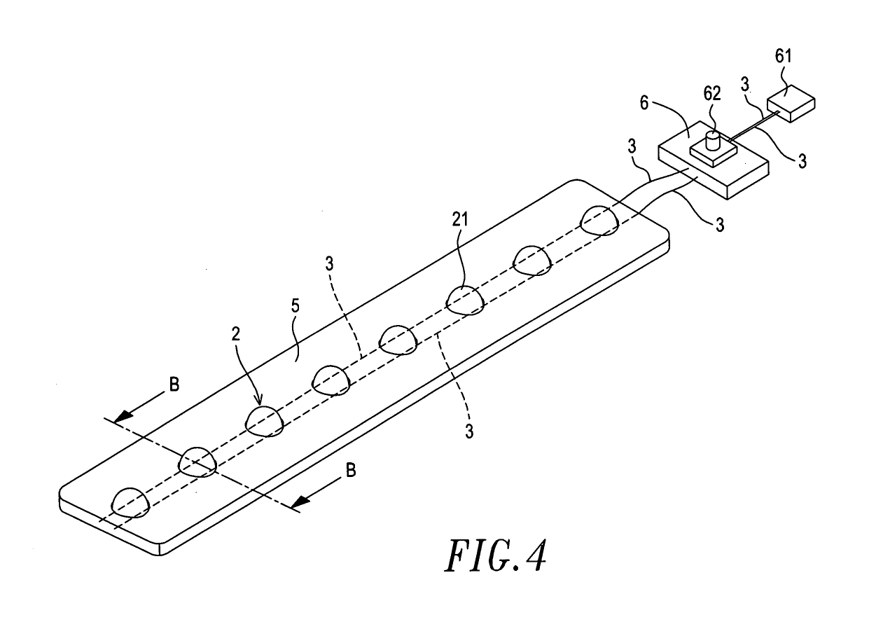

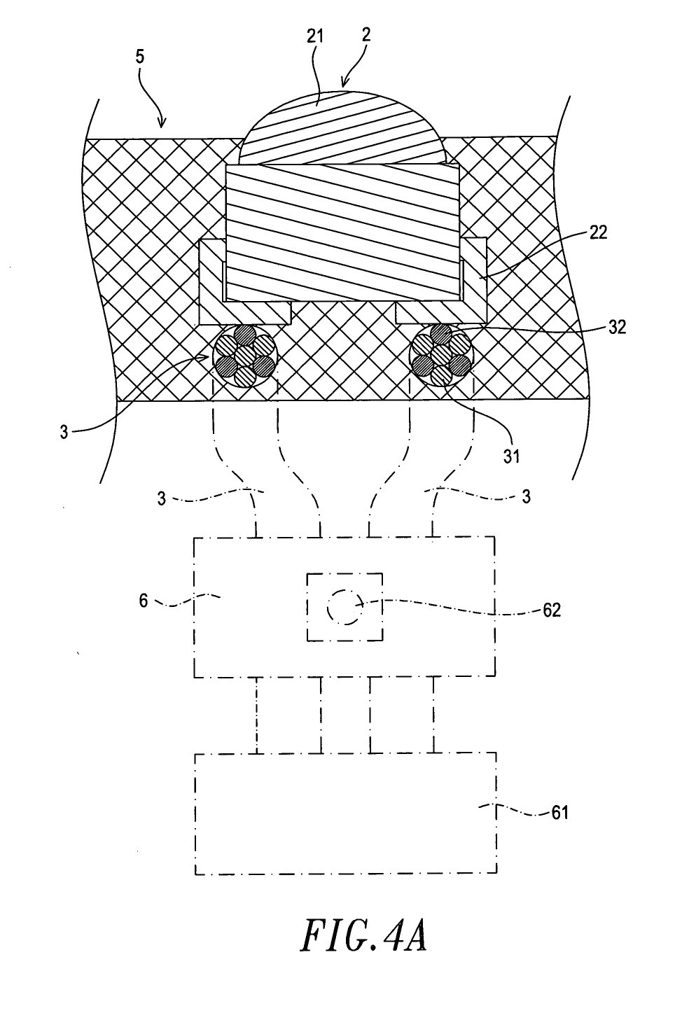

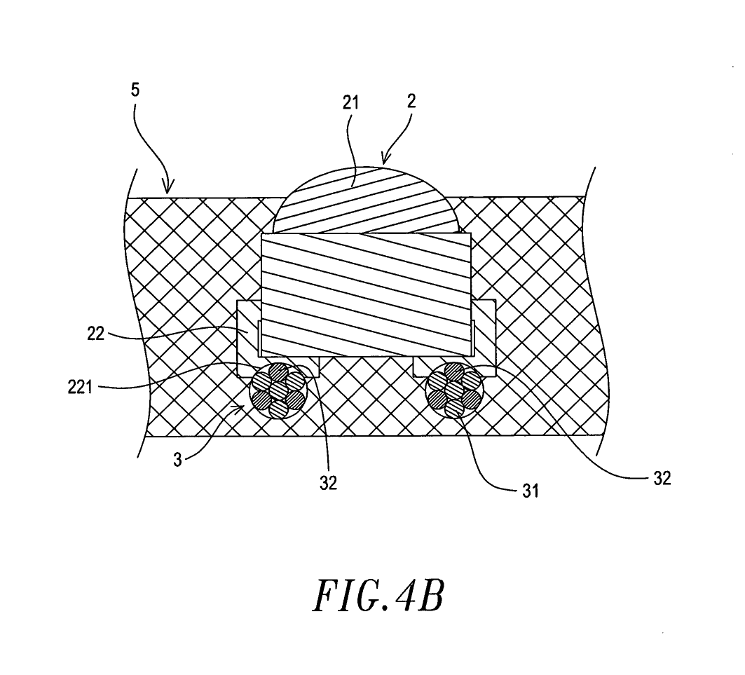

As to the light-emitting element 2, as shown in FIG. 4A, each light-emitting element 2 comprises a light emission section 21 and at least two conductive pins 22. The two conductive pins 22 are respectively in secured electrical engagement with the conductive wires 32 of the two conductive twisted cables 3. Fixed connection between the conductive pins 22 and the conductive twisted cables 3 can be realized through for example soldering, stamping and pressing, and application of adhesives.

Referring to a first embodiment according to the present invention shown in FIGS. 4 and 4A, the woven member 5 is coupled to the article 1 (by means of for example sewing or being woven on or inside the article 1, the former being shown in the drawings) and is attached to the shoulders and the back of the article 1 as shown in the drawings. The conductive twisted cables 3 are woven in the woven member 5 and the light-emitting elements 2 are arranged inside the woven member 5 with the conductive pins 22 of the light-emitting element 2 being in electrical engagement with the conductive twisted cables 3 for emission of light. Light emitting from the light emission section 21 of each light-emitting element 2 is allowed to project outside the woven member 5. As shown in the drawings, the projection of light is realized through a hole formed in the woven member 5 at a location corresponding to and thus exposing the light emission section 21. Alternatively, the woven member 5 may be formed of a loosened structure (not shown) at a corresponding location to allow the light to travel therethrough.

As such, the conductive twisted cables 3 and the stretch-resistant light-emitting structure comprising the conductive twisted cables 3 show the properties of stretch resistance, pull resistance, and deflectability and is of electrical conduction to energize the light-emitting elements 2 for emission of light.

Referring to a second embodiment according to the present invention shown in FIG. 4B, preferably, each of the conductive pins 22 of each light-emitting element 2 forms, in a bottom thereof, a positioning trough 221, and the positioning troughs 221 correspond respectively to the conductive twisted cables 3, whereby the conductive twisted cables 3 are respectively receivable and thus positionable in the positioning troughs 221 of the conductive pins 22. Further, the light-emitting element 2 shown in FIG. 4A or 4B is electrically connected to two conductive twisted cables 3 with the bottoms of the conductive pins 22 respectively contacting the conductive twisted cables 3 and the conductive wires 32 of the conductive twisted cables 3 in electrical engagement with the conductive pins 22.

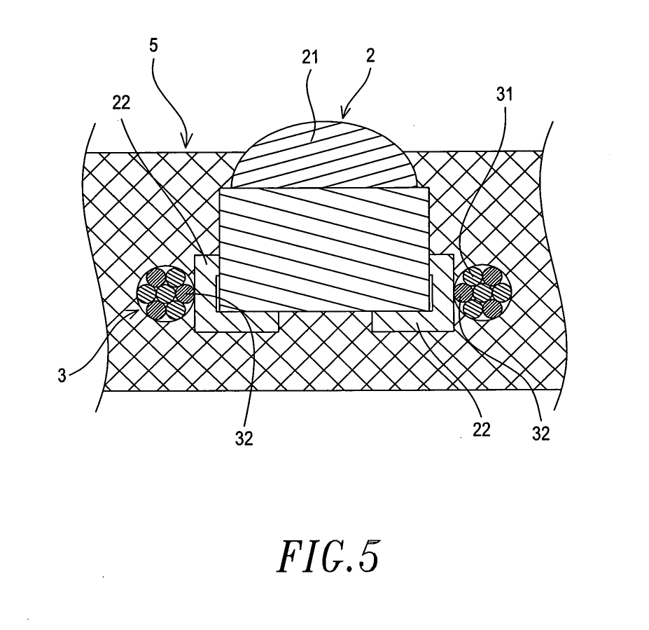

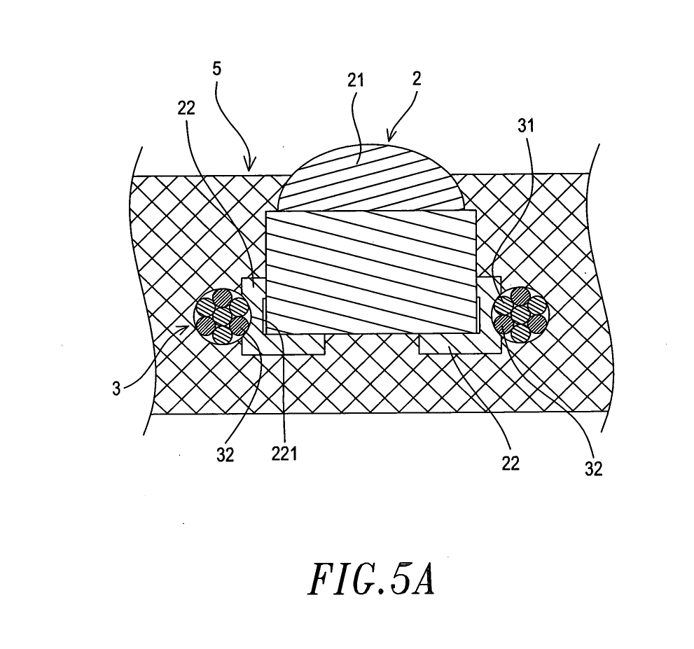

Referring to third and fourth embodiments according to the present invention shown in FIGS. 5 and 5A, the light-emitting element 2 is set between and in electrical connection with the two conductive twisted cables 3 with the conductive pins 22 contacting, at sides thereof, sides of the conductive twisted cables. Preferably, the side of each conductive pin 22 forms a positioning trough 221 (FIG. 5A), which corresponds to the conductive twisted cable 3, whereby the conductive twisted cables 3 are receivable and thus positionable in the positioning troughs 221 of the conductive pins 22 and the conductive wires 32 of the conductive twisted cables 3 in electrical engagement with the conductive pins 22.

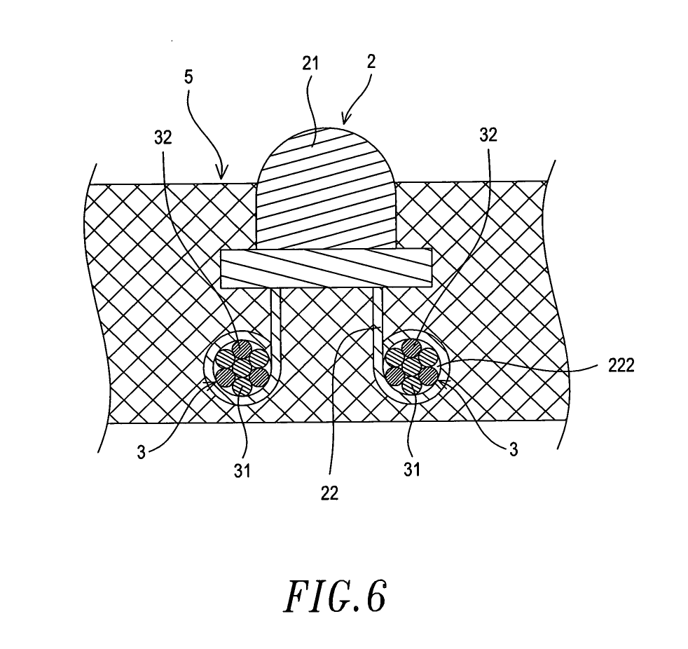

Referring to a fifth embodiment according to the present invention shown in FIG. 6, each conductive pin 22 of the light-emitting element 2 forms a positioning portion 222, which in the embodiment illustrated in the drawing comprises a through hole through which the respective conductive twisted cable 3 is received and thus positioned therein, whereby the conductive twisted cables 3 are positioned in and by the positioning portions 222 of the conductive pins 22 and the conductive wires 32 of the conductive twisted cables 3 are in electrical engagement with the conductive pins 22.

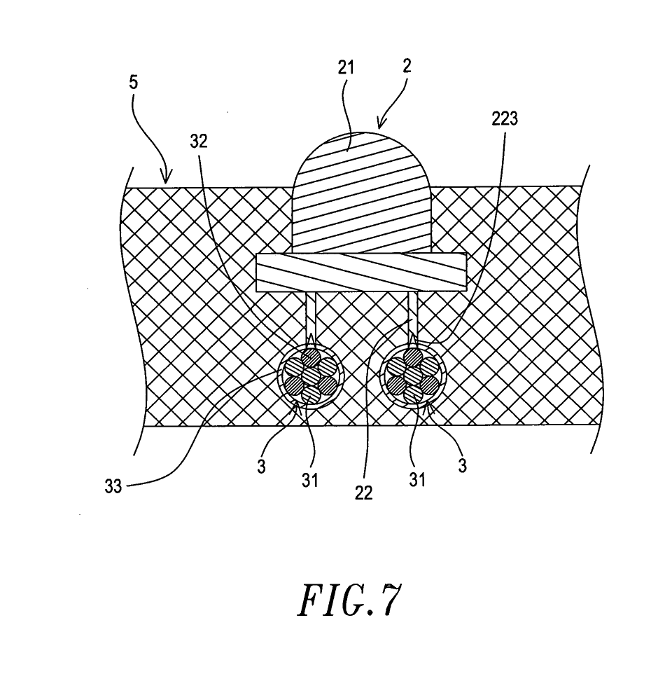

Referring to a sixth embodiment according to the present invention shown in FIG. 7, each of the conductive twisted cables 3 is enclosed by an insulation layer 33, and each of the conductive pins 22 of the light-emitting element 2 comprises a piercing tip 223. The piercing tips 223 of the conductive pins 22 respectively pierce through the insulation layers 33 of the conductive twisted cables 3 to form electrical engagement with the conductive wires 32 housed in the insulation layers 33. The insulation layer 33 can be formed in various ways, of which one is soaking in a solution or liquid of insulation material.

The first to sixth embodiments discussed above can realize insulation through the following processes that are not demonstrated in the drawings. The first way is that the conductive twisted cables 3 that are electrically connected with the light-emitting elements 2 are soaked in a liquid of insulation material to each form an insulation layer thereon, and then, the conductive twisted cables 3 that are enclosed by the insulation layers and are electrically connected with the light-emitting elements 2 are woven (simply woven) in the woven member 5, but not limited thereto; the second way is that the conductive twisted cables 3 are first formed with insulation layers 33, and then woven (subjected to a weaving operation with yarns of the woven member 5) in the woven member 5 so as to combine with the woven member 5, and then the insulation layer 33 is processed to form a plurality of openings that expose the conductive wires 32, through which openings electrical connection with the light-emitting elements 2 can be made, and finally, packaging or sealing with resin may be made.

In the first embodiment discussed above, the conductive twisted cables 3 (two conductive twisted cables 3 as shown in the drawing) of each of the stretch-resistant light-emitting structure can be selectively first covered with insulation and then entangled and twisted together (not illustrated). It is apparent that this is applicable to the second to sixth embodiments (not illustrated).

In the first to sixth embodiments discussed above, the stretch-resistant light-emitting structure may omit the woven member 5, and instead, two conductive twisted cables 3 are woven together with the threads of a sweater (not shown) so as to combined with the sweater.

Referring to FIGS. 1 and 2, the stretch-resistant heat-emitting structures are respectively mounted to front and back of the article 1. Each stretch-resistant heat-emitting structure comprises at least one carrying member 4, at least one electrical heating element 40, and at least two conductive twisted cables 3. In the embodiment shown in the drawings, each stretch-resistant heat-emitting structure comprises a carrying member 4, an electrical heating element 40, and two conductive twisted cables 3.

The carrying member 4 is woven (simply woven) with the article 1. Similar to what discussed above, the conductive twisted cable 3 comprises at least one stretch-resistant wire 31 and at least one conductive wire 32 twisted together. In the embodiment illustrated, each conductive twisted cable 3 comprises a plurality of stretch-resistant wires 31 and a plurality of conductive wires 32. Preferably, each conductive wire 32 is conductive wire made of a stretch-resistant material to provide the conductive wire 32 with the properties of stretch resistance, pull resistance, and deflectability. The electrical heating element 40 is mounted on the carrying member 4, and the conductive wires 32 of the two conductive twisted cables 3 are electrically connected to the electrical heating element 40.

The electrical heating element 40 generates through electrical power transmitted through the conductive twisted cables 3. Preferably, the carrying member 4 comprises a heat spreader (not shown), whereby the electrical heating element 40 is in contact engagement with the heat spreader to allow heat to be uniformly distributed through the heat spreader, so that the article 1 to which the stretch-resistant heat-emitting structure according to the present invention is mounted can realize the function of uniform heating.

In the first to sixth embodiments, each stretch-resistant light-emitting structure is selectively provided with a battery 61. This will be described as follows.

Referring to FIG. 4, the two conductive twisted cables 3 contained in the woven member 5 are further and electrically connected to a battery 61 (which is actually in electrical connection with the conductive wires 32 of the two conductive twisted cables 3, but for simplification of the description, in the following description, the conductive wire 32 will not be explicitly mentioned), whereby electrical power supplied from the battery 61 can be applied to the light-emitting elements 2 for emission of light.

Preferably, a control circuit 6 and a switch 62 are further provided as shown in the drawings, whereby the control circuit 6, the battery 61, and the switch 62 are electrically connected to the two conductive twisted cables 3. As such, the control circuit 6 controls the fashion of light emission of the light-emitting elements 2 (such as continuous emission, flashing, or lighting with various brightness). The control circuit 6, the battery 61, and the switch 62 may also be woven in the woven member 5 (not shown), or alternatively, as shown in the drawings, extending outside the woven member 5. In both arrangements, selective enclosure with insulation layer may be made to ensure electrical insulation in doing laundry or to realize insulating isolation in twisting conductive twisted cables 3 together. Further, to enhance control of the lighting fashion of the light-emitting element 2, at least one conductive twisted cables for controlling purposes (not shown in the drawings, but having the same structure as the conductive twisted cables 3) is additionally provided, whereby the controlling-purpose conductive twisted cable is in electrical connection with the control circuit 6 through conductive wires thereof and the controlling-purpose conductive twisted cable may transmit control signals from the control circuit 6. The two conductive twisted cables 3 and the controlling-purpose conductive twisted cable may be separately enclosed by an insulation layer and then twisted together (not shown) to provide improved stretch resistance and pull resistance.

In summary, the stretch-resistant light-emitting structure receives electrical power from the battery 61 for energizing the light-emitting elements 2 to give off light and comprises a switch 62 to selectively light on or off the light-emitting elements 2 and may further control, through the control circuit 6, the lighting fashion of the light-emitting element 2.

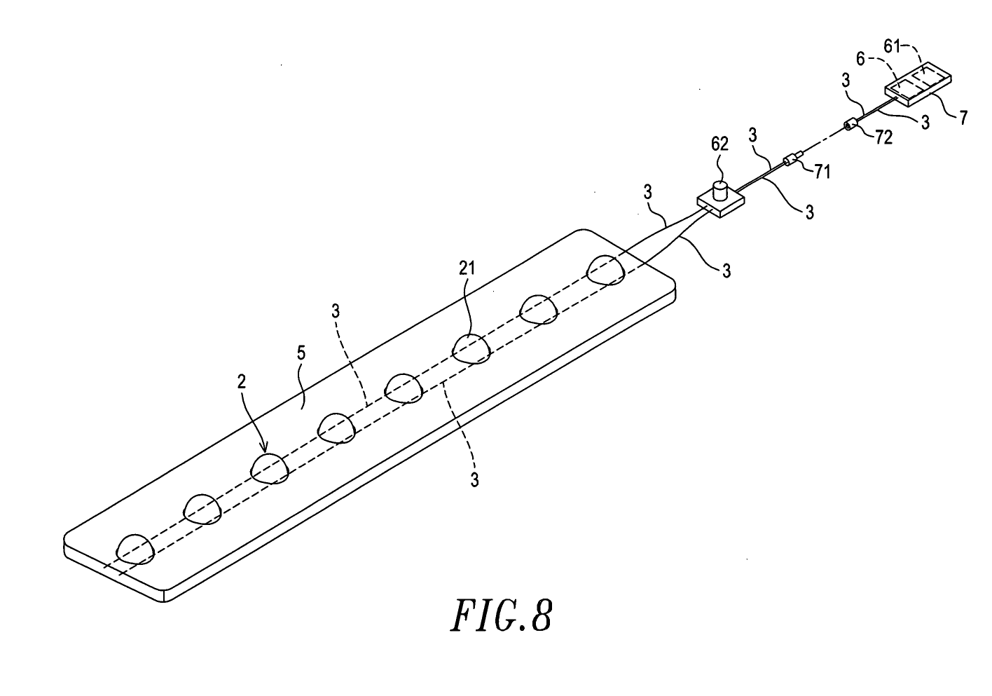

Referring to FIG. 8, external connection is used to replace the electrical connection with a battery 61 mentioned above (and preferably, the external connection comprises a control circuit 6). In the first to sixth embodiments according to the present invention, the stretch-resistant light-emitting structure comprises an external connecting member 7, a connector 71, and a switch 62. The connector 71 and the switch 62 are electrically connected to the two conductive twisted cables 3. The external connecting member 7 comprises a battery 61 and a control circuit 6 for controlling the lighting fashion of the light-emitting elements 2. The external connecting member 7 further comprises a connector 72 that is electrically connected to the control circuit 6 and is mateable with the connector 71. The external connecting member 7 is electrically connected through the mating engagement between the connector 72 and the connector 71. The switch 62 and the connector 71 may be selectively woven in the woven member 5 (not shown), or alternatively, extend outside the woven member 5. In both arrangements, selective enclosure with insulation layer may be made to ensure electrical insulation in doing laundry or to realize insulating isolation in twisting conductive twisted cables 3 together. Further, to enhance control of the lighting fashion of the light-emitting element 2, at least one conductive twisted cables for controlling purposes (not shown in the drawings, but having the same structure as the conductive twisted cables 3) is additionally provided, whereby the controlling-purpose conductive twisted cable is in electrical connection with the control circuit 6 through conductive wires thereof and the controlling-purpose conductive twisted cable may transmit control signals from the control circuit 6. The two conductive twisted cables 3 and the controlling-purpose conductive twisted cable may be separately enclosed by an insulation layer and then twisted together (not shown) to provide improved stretch resistance and pull resistance.

In summary, besides control of lighting on/off through the switch 62, selective external connection of the external connecting member 7 may be used to select use or no use of the battery 61 and the control circuit 6.

Each stretch-resistant heat-emitting structure is selectively provided with a battery 43. This will be described as follows.

Referring to FIGS. 1 and 2, the stretch-resistant heat-emitting structure is further electrically connected to a battery 43, whereby the switch 42 is turned on the allow electrical power to supply from the battery 43 to the heating element 40, and the heating element 40 generates and emits heat. Preferably, as shown in the drawings, a control circuit 41 and a switch 42 are further provided. The control circuit 41, the switch 42, and the battery 43 are electrically connected to the conductive twisted cables 3 for electrical connection with the heating element 40. The switch 42 controls heating (ON) or non-heating (OFF) status of the heating element 40. The control circuit 41 control heating operation of the heating element 40 (such as temperature and time counting).

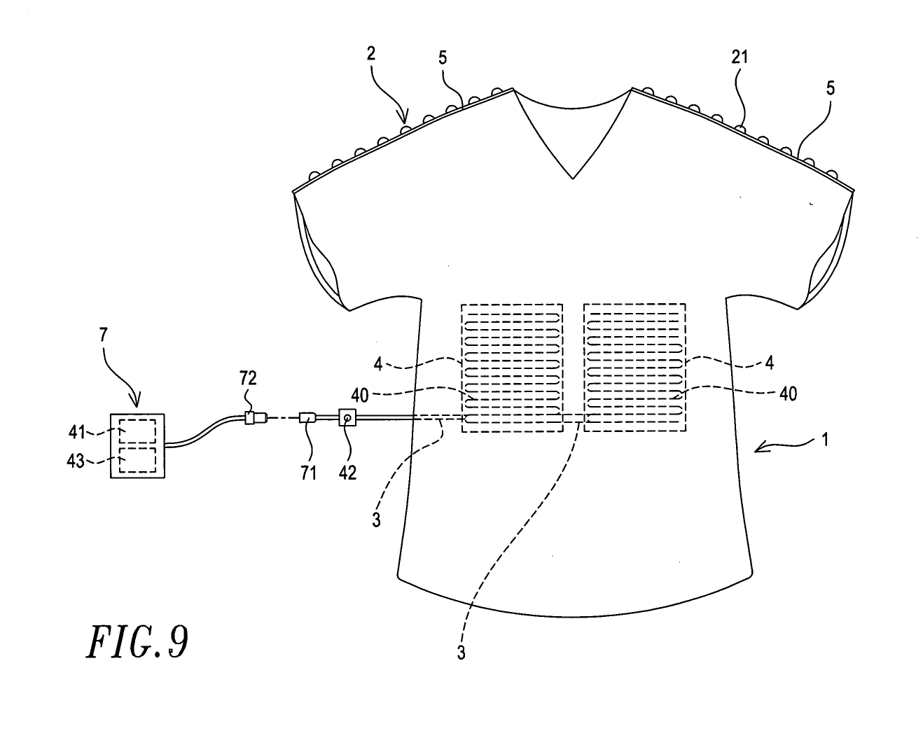

It is apparent that the battery 43 (or further comprising the control circuit 41) of the stretch-resistant heat-emitting structure can be connected in an external connection form (as shown in FIG. 9). The stretch-resistant heat-emitting structure further comprises a connector 71, a switch 42, and an external connecting member 7. The external connecting member 7 comprises a mateable counterpart connector 72, the control circuit 41, and the battery 43. The connector 71 and the switch 42 are electrically connected to the conductive twisted cables 3, while the control circuit 41, the battery 43 and the counterpart connector 72 of the external connecting member 7 are electrically connected together. As such, the external connecting member 7 is electrically connected through the mating engagement between the connector 72 and the connector 71.

As such, besides control of heating or not of the heating element 40 by the switch 42, selective external connection of the external connecting member 7 may be used to select use or no use of the battery 43 and the control circuit 41.

Further, the stretch-resistant light-emitting structure as shown FIGS. 4 and 8 and provided with the battery 61 may have a portion extending outside the woven member 5 and attached to any desired location on the article 1. The stretch-resistant heat-emitting structure that is provided with the battery 43 has a portion extending outside the carrying member 4 and attached to the article 1 at locations as shown in FIGS. 1 and 2.

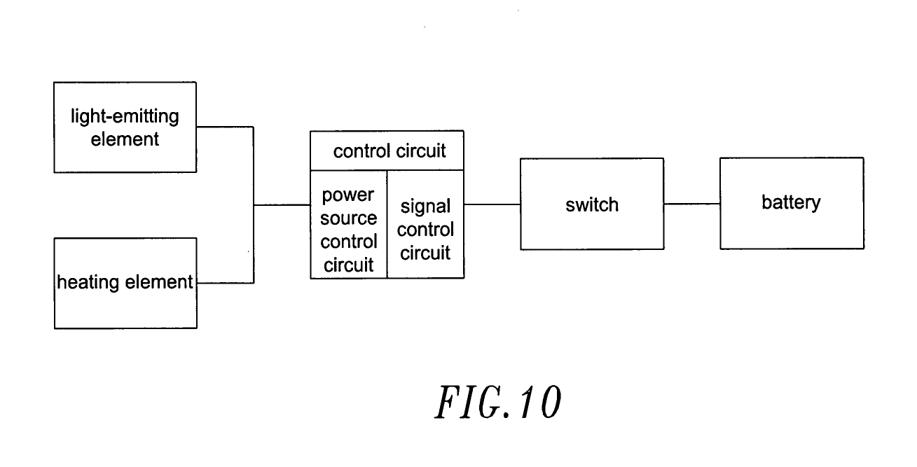

Referring to FIG. 10, a block diagram according to present invention comprising the battery, the control circuit, and the switch is shown. The light-emitting element of the stretch-resistant light-emitting structure, the heating element of the stretch-resistant heat-emitting structure, the control circuit, and the switch are electrically connected to the battery. The switch controls if the supply of electrical power from the battery is made or not. The control circuit comprises a power source control circuit and a signal control circuit. The power source control circuit controls if the light-emitting element or the heating element is set ON or OFF. The signal control circuit controls the lighting fashion of the light-emitting element and the heating operation of the heating element (such as temperature and time counting).

The features of the stretch-resistant light-emitting or heat-emitting structure according to the present invention are that through the unique arrangement of the conductive twisted cables 3, the stretch-resistant light-emitting structure that allows electrical power to transmit through the conductive twisted cables 3 to the light-emitting elements 2 and the stretch-resistant heat-emitting structure that allows electrical power to transmit through the conductive twisted cables 3 to the heating element 40 provide the functions of stretch resistance, pull resistance, water washability, and deflectability, in addition to light emission and heat emission, so as to be perfectly suitable for applications in an articles 1, such as garment, jacket, shirt, vest, underwear, pants, skirt, hat, glove, swimming suit, swimming cap, wet suit, sock, earmuffs, and bag and backpack. Further, through the battery 61, 43, electrical power is supplied to the light-emitting elements 2 and the heating element 40; through the switch 62, 42, the light-emitting element 2 can be controlled to light or not and the heating element 40 can be controlled to give off heat or not; through the control circuit 6, 41, the lighting fashion of the light-emitting element 2 is controlled and the heating operation of the heating element 40 is controlled; through the external connecting member 7, the use of the battery 61, 43 and the control circuit 6, 41 can be easily selected. Further, through the arrangement of a controlling-purpose conductive twisted cable, control signals from the control circuit 6, 41 can be transmitted; through the covering of insulation layer, ensure electrical insulation in doing laundry may be ensured and insulating isolation may be realized in twisting conductive twisted cables 3 together. Further, the battery 61, 43 may be a sheet like flexible battery, which was recently developed, to get better fit to applications in articles to be worn on a human body.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A stretch-resistant light-emitting structure, which is adapted to be used in an article, the stretch-resistant light-emitting structure comprising:
a woven member, which is mounted to the article;
at least two conductive twisted cables, each of which comprises at least one stretch-resistant wire and at least one conductive wire twisted together, the two conductive twisted cables being woven in the woven member;
at least one light-emitting element, which is arranged inside the woven member, the light-emitting element comprising a light emission section and at least two conductive pins, the light emission section emitting light projecting out of the woven member, the two conductive pins being respectively and securely in electrical engagement with the conductive wires of the two conductive twisted cables; and
a battery, which is electrically connected to the conductive wires of the two conductive twisted cables to supply electrical power to the light-emitting element.

2. The stretch-resistant light-emitting structure as claimed in claim 1, wherein the conductive wire of each of the conductive twisted cables comprises a conductive wire made of a stretch-resistant material.

3. The stretch-resistant light-emitting structure as claimed in claim 1, wherein each of the conductive pins of the light-emitting element forms a positioning trough corresponding to the respective the conductive twisted cable whereby the conductive twisted cables are respectively positionable in the positioning troughs of the conductive pins.

4. The stretch-resistant light-emitting structure as claimed in claim 1, wherein each of the conductive pins of the light-emitting element forms a positioning portion, whereby the conductive twisted cables are respectively positionable in the positioning portions of the conductive pins.

5. The stretch-resistant light-emitting structure as claimed in claim 4, wherein the positioning portion of the conductive pin comprises a through hole through which the conductive twisted cable is receivable and positionable in the conductive pin.

6. The stretch-resistant light-emitting structure as claimed in claim 1, wherein each of the conductive twisted cables is enclosed by an insulation layer, each of the conductive pins of the light-emitting element comprises a piercing tip, the piercing tips of the conductive pins piercing through the insulation layers of the conductive twisted cables to electrically engage the conductive wires enclosed by the insulation layers.

7. The stretch-resistant light-emitting structure as claimed in claim 1 further comprising a control circuit and a switch, wherein the control circuit, the switch, and the battery are electrically connected to the conductive wires of the two conductive twisted cables, the control circuit controlling lighting fashion of the light-emitting element.

8. The stretch-resistant light-emitting structure as claimed in claim 7, wherein the at least two conductive twisted cables further comprise at least one controlling-purpose conductive twisted cable, the controlling-purpose conductive twisted cable being electrically connected through conductive wires thereof to the control circuit.

9. The stretch-resistant light-emitting structure as claimed in claim 1 further comprising an external connecting member, a connector, and a switch, wherein the connector and the switch are electrically connected to the conductive wires of the two conductive twisted cables, the external connecting member comprising a battery and a control circuit that controls lighting fashion of the light-emitting element, the external connecting member further comprising a counterpart connector that is electrically connected to the control circuit and is mateable with the connector, the external connecting member being electrically connectable through mating engagement between the counterpart connector and the connector.

10. The stretch-resistant light-emitting structure as claimed in claim 9, wherein the at least two conductive twisted cables further comprise at least one controlling-purpose conductive twisted cable, the controlling-purpose conductive twisted cable being electrically connected through conductive wires thereof to the control circuit.

11. The stretch-resistant light-emitting structure as claimed in claim 1, 8, or 10, wherein each of the conductive twisted cables is enclosed by an insulation layer, the conductive twisted cables being twisted together.

12. A stretch-resistant heat-emitting structure, which is adapted to be used in an article, the stretch-resistant heat-emitting structure comprising:
at least one carrying member, which is woven in the article;
at least one electrical heating element, which is mounted to the carrying member;
at least two conductive twisted cables, each of which comprises at least one stretch-resistant wire and at least one conductive wire twisted together, the conductive wires of the two conductive twisted cables each having an end electrically connected to the electrical heating element; and
a battery, which is electrically connected to an opposite end of each of the conductive wires of the conductive twisted cables for supply of electrical power thereto.

13. The stretch-resistant heat-emitting structure as claimed in claim 12, wherein the conductive wire of each of the conductive twisted cables comprises a conductive wire made of a stretch-resistant material.

14. The stretch-resistant heat-emitting structure as claimed in claim 12, wherein the carrying member comprises a heat spreader, the electrical heating element being in engagement with the heat spreader.

15. The stretch-resistant heat-emitting structure as claimed in claim 12 further comprising a switch, wherein the switch and the battery are electrically connected through the conductive twisted cables to the electrical heating element.

16. The stretch-resistant heat-emitting structure as claimed in claim 15 further comprising a control circuit, wherein the switch, the battery, and the control circuit are electrically connected through the conductive twisted cables to the electrical heating element.

17. The stretch-resistant heat-emitting structure as claimed in claim 12 further comprising an external connecting member, a connector, and a switch, wherein the connector and the switch are electrically connected through the conductive twisted cables to the electrical heating element, the external connecting member comprising a battery and a counterpart connector mateable with the connector, the counterpart connector being electrically connected to the battery, the external connecting member being electrically connectable through mating engagement between the counterpart connector and the connector.

18. The stretch-resistant heat-emitting structure as claimed in claim 17, wherein the external connecting member further comprises a control circuit, the counterpart connector and the battery of the external connecting member being electrically connected to the control circuit.
